(19) United States
(12) Patent Application Publication
(10) Pub. No.: US 2011/0156849 A1
(43) Pub. Date: Jun. 30, 2011

(54) METHOD FOR INFLUENCING THE MAGNETIC COUPLING BETWEEN TWO BODIES AT A DISTANCE FROM EACH OTHER AND DEVICE FOR PERFORMING THE METHOD

(75) Inventors: Vadim Gogichev, Moscow (RU); Peter Smyslov, Moscow (RU); Jean Schlagenwarth, Irdenving (CH)

(73) Assignee: PHILIPPE SAINT GER AG, Zug (CH)

(21) Appl. No.: 12/600,199

(22) PCT Filed: May 15, 2008
(86) PCT No.: PCT/EP08/03917

§ 371 Date: Jan. 19, 2011

(30) Foreign Application Priority Data
May 15, 2007 (CH) 796/07
Jun. 25, 2007 (CH) 1010/07
May 15, 2008 (EP) PCT/EP2008/003917

(51) Int. Cl. H01F 7/04; H01F 7/06

(52) U.S. Cl. 335/295

(57) ABSTRACT

Method for influencing the magnetic coupling between two bodies (10, 12), which are at a distance from one another, characterized in that a controllable field displacement apparatus (13) which has a field displacement region is fitted between the two bodies (10, 12), and in that the magnetic field (11) between the two bodies (10, 12) is displaced in a predetermined manner from the field displacement region of the field displacement apparatus (13) by appropriately driving the field displacement apparatus (13).

### TECHNICAL FIELD

The present invention relates to the field of influencing magnetic fields. It relates in particular to a method for influencing the magnetic coupling between two bodies which are at a distance from one another, according to the precharacterizing clause of Claim 1, and to an apparatus for carrying out the method.

### PRIOR ART

Diamagnetism is defined as a characteristic of a substance of displacing to a greater or lesser extent a magnetic field which passes through it from its interior, and of attenuating the magnetic field. An ideal diamagnet is a superconductor of a first type, which completely displaces the magnetic field from its interior, with the exception of a narrow edge area. In the case of diamagnetic material, circulating currents are induced by the outer magnetic field at the atomic level on the basis of the proposed model, the magnetic field of which circulating currents opposes the outer magnetic field and attenuates it. In the case of the superconductor of the first type, a zero-loss screen current is created in the edge area in the macroscopic dimension by the outer magnetic field, and its magnetic field results in there being no field in the interior of the superconductor.

Because of the field displacement, the magnetic coupling between two bodies can in principle be varied (attenuated) by a diamagnetic body, when the diamagnetic body is brought into the region of the magnetic coupling between the bodies. It is not possible to control this process, and in particular it is not possible to switch the field displacement on and off easily.

### DESCRIPTION OF THE INVENTION

The object of the invention is to specify a method and an apparatus by means of which the magnetic coupling between two bodies can be influenced and controlled easily and specifically.

The object is achieved by the totality of the features of Claims 1 and 10. It is essential for the invention that a controllable field displacement apparatus which has a field displacement region is fitted between the two bodies, and that the magnetic field between the two bodies is displaced in a predetermined manner from the field displacement region of the field displacement apparatus by appropriately driving the field displacement apparatus. The field displacement apparatus in this case defines a spatial region in which there is a magnetic induction flux density B where divB=0, and there is a vector potential A where rotA=0 and B=0 in its outer area.

One control possibility is to switch the field displacement apparatus on or off in order to influence the magnetic coupling between the two bodies. This results in a change between full field displacement and no field displacement, corresponding to a switching process for the magnetic coupling.

In order to achieve a periodically varying coupling, such as that which occurs for example in conjunction with induced alternating currents, the field displacement apparatus can be switched on and off periodically in order to influence the magnetic coupling between the two bodies.

However, it is also feasible to vary the strength of the field displacement of the field displacement apparatus in order to influence the magnetic coupling between the two bodies, in order to achieve a continuous change, such as that which occurs, for example, during sinusoidal processes.

In this case, at least one toroidal coil, which is intrinsically closed, is preferably used to produce the field displacement region. Furthermore, the vector potential can be influenced by a winding through which current flows and which runs within the at least one toroidal coil, in the direction of the axis of the toroidal coil.

The magnetic coupling to be influenced may exist between identical bodies or different bodies. At least one of the bodies may therefore be a permanent magnet, whose magnetic field interacts with another body. In particular, both bodies may be permanent magnets, which attract or repel one another in the course of their interaction, depending on the polarity.

At least one of the bodies may, however, also be an electromagnetic coil which either has a current flowing through it itself and produces a magnetic field, or through which a varying magnetic field flows, as an induction coil. In particular, both bodies may be electromagnetic coils.

In this case, a controller is preferably used in order to control the field displacement apparatus.

One refinement of the field displacement apparatus according to the invention is characterized in that the field displacement apparatus has at least one toroidal coil whose inner magnetic field is closed in the form of a ring and whose outer magnetic field disappears. In particular, a winding (31) to which current can be applied and which runs in the direction of the axis of the toroidal coil can be arranged within the at least one toroidal coil.

According to one preferred development of this refinement, a plurality of toroidal coils which are directly adjacent to one another on a plane are arranged concentrically one inside the other.

A particularly uniform field displacement region can be produced in the field displacement apparatus if a plurality of toroidal coils which are each directly adjacent to one another on two planes which are arranged one above the other, are arranged concentrically one inside the other.

The toroidal coils or the winding are/is in this case preferably connected to an electrical power supply, which is itself controlled by a controller.

### BRIEF EXPLANATION OF THE FIGURES

The invention will be explained in more detail in the following text using exemplary embodiments and in conjunction with the drawing, in which:

FIG. 1 shows, in a highly simplified form, various steps (FIGS. 1a to 1d) for influencing the magnetic coupling between two permanent magnets, according to one exemplary embodiment of the method according to the invention;

FIG. 2 shows a section through a toroidal coil, as is part of a field displacement apparatus according to one exemplary embodiment of the invention;

FIG. 3 shows a cross section through one exemplary embodiment of the field displacement apparatus according to the invention, having concentric toroidal coils, which are operated alternately, on two planes which are located one above the other;

FIG. 4 shows an illustration, comparable to FIG. 1, of an arrangement in which the coupling between a permanent magnet and an electromagnetic coil is influenced according to the invention;

FIG. 5 shows an illustration, comparable to FIG. 4, of an arrangement in which the coupling between two electromagnetic coils is influenced according to the invention; and

FIG. 6 shows a section through a field displacement apparatus according to another exemplary embodiment of the invention, with a toroidal coil and an additional winding running around in it, in order to control the vector potential.

### APPROACHES TO IMPLEMENTATION OF THE INVENTION

The invention relates to the manner in which phenomena and effects of diamagnetism can be produced in a fixed predetermined region in space (field displacement region) and how this diamagnetic spatial region which is produced by external currents (field displacement region) can be used for interaction of magnetic or electromagnetic fields which are constant or which vary over time, and which extend into this region from different external independent sources (for example external permanent magnets or electromagnets).

In particular, the proposal covers the control of the outer steady-state fluxes, and/or fluxes which vary over time, of the magnetic fields which originate from the external sources.

In order to produce the diamagnetic spatial region, a specific field displacement apparatus is proposed, specifically a diamagnetism generator (DMG in the following text), whose variables and parameters are annotated with the index _{D}. Within the fixed predetermined spatial region, the DMG produces closed circulations of the magnetic flux density of a magnetic field B_{D} which is constant and/or varies over time, where divB_{D}=0 (in the interior of the spatial region). Outside the fixed spatial region, a vector potential A_{D} is produced with the radial gradient (gradA_{r,D}), where rotA_{D}=0 and B_{D}=0. The fixed interaction of these two regions acts like the phenomenon of diamagnetism in the relationships with other external fluxes of the magnetic and/or electromagnetic fields, which extend into this region from other external sources (for example permanent magnets or electromagnets).

By way of example, a circular solenoid (toroidal coil) which is supplied from an electrical power source can be used as a DMG, producing a circular, intrinsically closed, electromagnetic field B_{D} (the direction of the field B_{D} is along the axis of the circular solenoid). An outer circular region of the vectorial potential A_{D} also exists, with the radial gradient (gradA_{r,D}) and the parameters on this region B_{D}=0, rotA_{D}=0. If the solenoid is supplied with direct current, then dA_{D}/dt=0. If, in contrast, the solenoid is supplied with alternating current, then dA_{D}/dt=A_{0.D}*K_{D}*f(v) where A_{0.D}=the amplitude of the vectorial potential A_{D}, f(v)=a function of the frequency of the alternating current, and K_{D}=a correction coefficient, which takes account of the wave phenomenon forms of A_{D}.

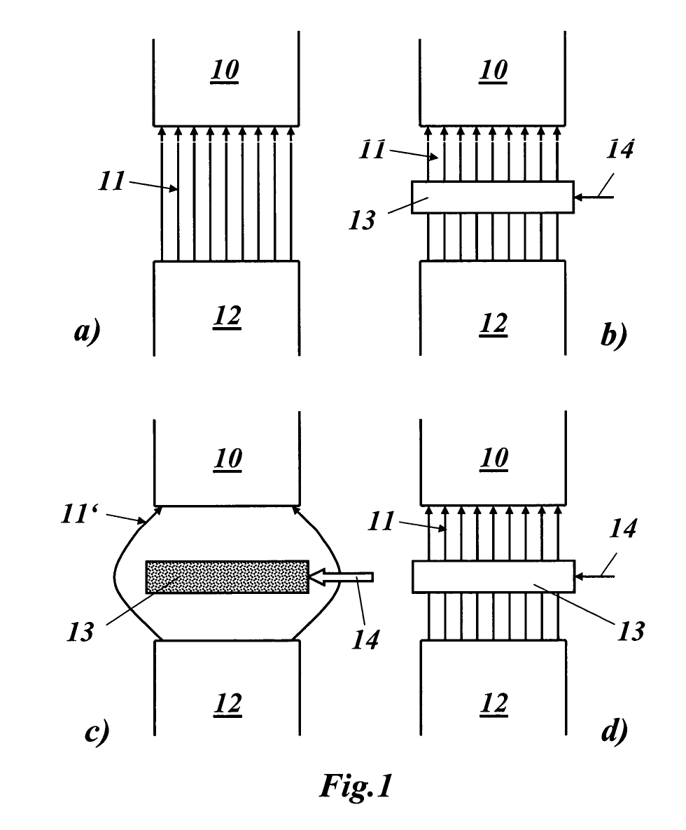

FIG. 1 shows a highly simplified illustration of the principle of the method according to the invention in the form of various steps (figure elements). According to FIG. 1a, the method is based on two bodies 10 and 12, which are at a distance from one another and are in this case, by way of example, in the form of permanent magnets, and which are magnetically coupled such that a region is formed between them with a magnetic induction flux density 11 which is not zero. In the present example, the opposite poles of the two permanent magnets face one another, as a result of which the magnetic interaction exerts an attraction force on the two bodies 10, 12.

Now, according to the invention, a controllable field displacement apparatus 13 is introduced into the region of the magnetic induction flux density 11 which is not zero and has a control input 14 (illustrated symbolically by an arrow) for external control (FIG. 1b). In this case, the field displacement apparatus 13 is preferably positioned such that the action of the field displacement is a maximum on the magnetic coupling of the two bodies 10, 12.

When the field displacement apparatus 13 is now switched on (symbolized by the block arrow at the control input 14 in FIG. 1c) the field displacement that this results in produces a different magnetic induction flux density 11′, which results in correspondingly different magnetic coupling between the bodies. When the field displacement apparatus 13 is switched off again (FIG. 1d), the original state from FIG. 1a is produced again.

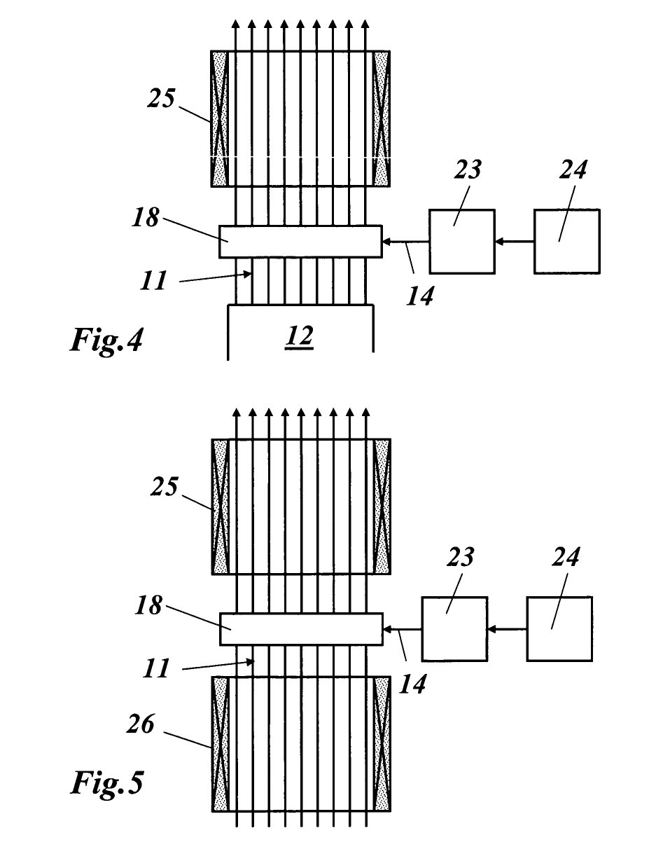

Instead of the magnetic coupling between two permanent magnets, the field displacement apparatus 18—as shown in FIGS. 4 and 5—may, however, also be used to influence the magnetic coupling between a permanent magnet 12 and an electromagnetic coil 25 (FIG. 4), or between two electromagnetic coils 25 and 26 (FIG. 5), in which case the electromagnetic coils 25, 26 are either themselves used to produce a magnetic constant field or alternating field, or for induction of a current by variation of the injected magnetic field.

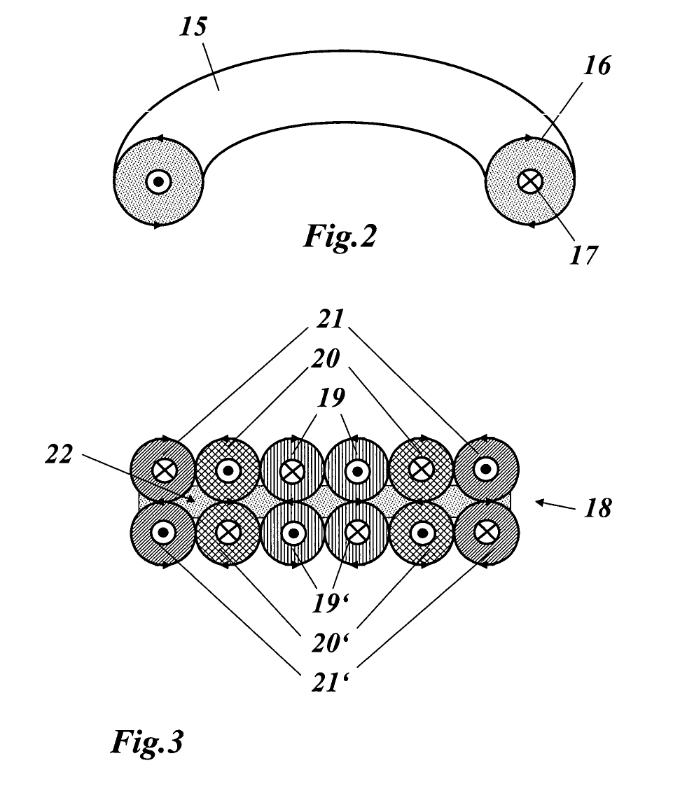

The central element of one exemplary embodiment of the field displacement apparatus 13 or 18 according to the invention is a toroidal coil 15 of the type shown in the form of a section in FIG. 2, in the interior of which the coil current forms a magnetic induction flux 17, which is closed in the form of a ring, while there is no field in the outer area.

If, as shown in FIG. 3, a plurality of toroidal coils 19, . . . ,21 and 19′, . . . ,21′ which are each directly adjacent to one another on two planes which are arranged one above the other are arranged concentrically one inside the other in order to form a field displacement apparatus 18, a (diamagnetically acting) field displacement region 22 is formed between the coil planes and has the effect shown in FIG. 1c when the coils 19, . . . ,21 and 19′, . . . ,21′ are switched on. In this case, the toroidal coils 19, . . . ,21 and 19′, . . . ,21′ are operated alternately both within each plane and between the planes.

Influencing the magnetic coupling makes it possible not only to influence (switch) magnetic forces but also to control inductive processes which may be involved with the production and processing of alternating currents.

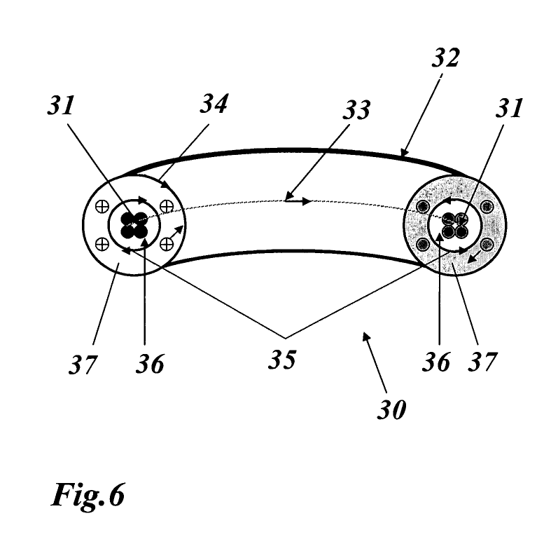

FIG. 6 shows another exemplary embodiment of a field displacement apparatus according to the invention, in an illustration comparable to FIG. 2. The field displacement apparatus 30 in FIG. 6 has a toroidal coil 32 which extends along a central (circular) axis 33 and through which a coil current 34 flows. The coil current 34 produces a magnetic field B_{D} in the field region, which is directed into the plane of the drawing on the left and out of the plane of the drawing on the right. An additional winding 31 is arranged along the axis 33 in the interior of the toroidal coil 32 (by way of example and without any restriction to generality, FIG. 6 shows four turns), which produces an additional magnetic field B_{V} in a further field region 36, which is oriented parallel to the coil current 34 and at right angles to the magnetic field B_{D} of the toroidal coil 32.

The variable gradA_{r,D} is influenced by the additional winding 31. The vectorial potential A_{r,D} and the variable gradA_{r,D} are influenced by the interaction of the two fields Bᵥ and B_{D}, in which case it is possible to vary the current through the winding 31 to create an influence, without having to vary the coil current 34 in the toroidal coil 32. This results in additional possible ways to influence magnetic couplings by means of the diamagnetic field displacement region.

### LIST OF REFERENCE SYMBOLS

10,12 Permanent magnet
11,11′ Magnetic induction flux density
13,18,30 Field displacement apparatus (controllable)
14 Control input
15 Toroidal coil
16 Coil current
17 Magnetic induction flux
19,20,21 Toroidal coil
19′,20′,21′ Toroidal coil
22 Field displacement region
23 Electrical power supply
24 Controller
25,26 Electromagnetic coil
31 Winding
32 Toroidal coil
33 Axis (toroidal coil)
34 Coil current
35 Magnetic field (winding 31)
36,37 Field region

1. A method for influencing the magnetic coupling between two bodies, which are at a distance from one another, wherein a controllable field displacement apparatus which has a field displacement region is fitted between the two bodies, and a magnetic field between the two bodies is displaced in a predetermined manner from the field displacement region of the field displacement apparatus by appropriately driving the field displacement apparatus.

2. The method according to claim 1, wherein the field displacement apparatus is switched on or off in order to influence the magnetic coupling between the two bodies.

3. The method according to claim 1, wherein the field displacement apparatus is switched on and off periodically in order to influence the magnetic coupling between the two bodies.

4. The method according to claim 1, wherein the strength of the field displacement of the field displacement apparatus is varied in order to influence the magnetic coupling between the two bodies.

5. The method according to claim 1, wherein at least one toroidal coil, which is intrinsically closed, is used to produce the field displacement region.

6. The method according to claim 5, wherein the vector potential (A_{r,D}) is influenced by a winding through which current flows and which runs within the at least one toroidal coil, in the direction of the axis of the toroidal coil.

7. The method according to claim 1, wherein at least one of the bodies is a permanent magnet.

8. The method according to claim 7, wherein both bodies are permanent magnets.

9. The method according to claim 1, wherein at least one of the bodies is an electromagnetic coil.

10. The method according to claim 9, wherein both bodies are electromagnetic coils.

11. The method according to claim 1, wherein a controller is used in order to control the field displacement apparatus.

12. A field displacement apparatus for carrying out the method of claim 1, wherein the field displacement apparatus defines a spatial region in which there is a magnetic induction flux density B where divB=0, and there is a vector potential A where rotA=0 and B=0 in its outer area.

13. The field displacement apparatus according to claim 12, wherein the field displacement apparatus has at least one toroidal coil whose inner magnetic field is closed in the form of a ring and whose outer magnetic field disappears.

14. The field displacement apparatus according to claim 13, wherein a winding to which current can be applied and which runs in the direction of the axis of the toroidal coil is arranged within the at least one toroidal coil.

15. The field displacement apparatus according to claim 13, wherein a plurality of toroidal coils which are directly adjacent to one another on a plane are arranged concentrically one inside the other.

16. The field displacement apparatus according to claim 15, wherein a plurality of toroidal coils which are each directly adjacent to one another on two planes which are arranged one above the other, are arranged concentrically one inside the other.

17. The field displacement apparatus according to claim 12, wherein the toroidal coil or coils or the winding is (are) connected to an electrical power supply, which is itself controlled by a controller.
